(19) United States
(12) Patent Application Publication
(10) Pub. No.: US 2016/0340250 A1
(43) Pub. Date: Nov. 24, 2016

(54) PROCESS FOR PRODUCING DEPOLYMERIZED HYDROCARBON PRODUCTS FROM COAL

(71) Applicant: QUANTEX RESEARCH CORPORATION, Kitchener (CA)

(72) Inventors: Gilbert A. Chalifoux, Mississauga (CA); Elliot B. Kennel, Morgantown, WV (US)

(21) Appl. No.: 15/159,419

(22) Filed: May 19, 2016

Related U.S. Application Data
(60) Provisional application No. 62/164,727, filed on May 21, 2015.

(51) Int. Cl. C04B 26/26; C10G 1/02

(52) U.S. Cl. CPC C04B 26/26; C10G 1/02; C10G 2300/44

(57) ABSTRACT

Disclosed herein is a method of producing hydrocarbon products from coal including a pitch material usable as asphalt pitch, comprising depolymerizing coal and digestion of coal in a high temperature depolymerizing medium consisting of a blend of heavy aromatic hydrocarbon oils, heating the coal to a temperature between 350° C. and 450° C. to create digested coal, and concentrating solid mineral matter and insoluble carbon via centrifugation, to obtain a synthetic asphalt pitch incorporating dispersed mineral matter and insoluble carbon as well as liquid hydrocarbons.

### CLAIM TO PRIORITY

This application claims the benefit of the following provisional applications, each of which is hereby incorporated by reference in its entirety: U.S. Provisional Patent Application No. 62/164,727, filed May 21, 2015 (QUAN-0006-P01).

### BACKGROUND

1. Field

This application relates to the co-production of hydrocarbon products from coal including a pitch material usable as asphalt. Coal liquids are obtained by processing of coal and blended coal depolymerization medium to depolymerize coal, thus creating a slurry of liquefied coal, fixed carbon and mineral matter. Most of the coal and mineral matter are removed via centrifugation. The separated solids also contain heavy hydrocarbon liquid from coal, thus resulting in a viscous tar usable as asphalt pitch. In addition, the mineral matter naturally present in the recovered coal solids may optionally be augmented by blending fly ash to create a cement or asphalt concrete suitable for structures such as roads, pavement, buildings and others.

2. Description of the Related Art

Coal liquefaction and depolymerization has been developed as a means to liquefy coal, providing a heavy crude especially conducive to heavy, carbon-rich products such as cokes, pitches and fuel oils, but which also contain a small fraction of lighter hydrocarbons suitable for producing lighter products including diesel, jet fuel and gasoline. Generally solid fuel is unsuitable for transportation fuels, and so for that reason, processes have been developed to convert solid coal to liquid products. Because coal is usually hydrogen-poor compared to many forms of petroleum crude, additional processing is necessary in order to improve the yield of hydrogen-rich liquids such as gasoline, diesel, jet fuel and the like. Alternatively, if liquefied coal can be used to produce carbon-rich products such as binder grade pitch, or coke, additional hydrogen is not necessary. Once coal is incorporated in a depolymerizing medium, especially at high temperature, the coal is mostly liquid and can flow. Removal of remaining solids including mineral matter (often referred to interchangeably as “ash” though in reality mineral matter only becomes ash after carbon is burned, leaving ceramic oxide residue) and insoluble fixed carbon occurs by centrifugation or filtration. The liquid hydrocarbon portion is refined or upgraded as a coal tar or heavy crude oil, whereas the underflow from the centrifuge is suitable for asphalt pitch. This asphalt pitch can be referred to as a synthetic asphalt pitch as it results from coal liquefation. It consists of aromatic coal constituents, mineral matter (ash) and insoluble carbon, as well as at least 10% liquefied coal. The synthetic asphalt pitch is distinguished from other synthetic pitches created by distilling, cracking or hyrogenating the liquid hydrocarbon portion.

Likewise, processes have been developed seeking to produce synthetic pitch via solvent extraction of coal [Wombles, Stansberry and Zondlo, 2001]. Patents related to this process include: U.S. Pat. No. 8,597,503, U.S. Pat. No. 8,465,561, U.S. Pat. No. 8,423,976, and US 8226816. These processes result in the production of high quality pitch after digestion, ash removal and distillation. The distilled overhead liquids are optionally usable as a coal solvent. However, in each case, the amount of solvent produced is less than the solvent consumed in the process.

Optionally, synthetic pitch is also suitable for coking. That is, when heated in a non-oxidizing environment, pitch melts and devolatilizes, leading to a solid carbon coke. These volatile liquids can be condensed to create a crude hydrocarbon liquid similar to crude petroleum. Bituminous coal, sub-bituminous coal and lignite coal have all been used successfully. However, these processes do not produce excess solvent. If the pitch is converted to coke, the total sum of liquids produced during the process can be greater than the amount of liquids consumed in the digestion step. Binder grade pitch normally requires that the ash content be below 0.5% by mass.

Optionally the synthetic asphalt pitch may be mixed with fly ash, such as Class C or Class F Pozzolanic Fly Ash (see ASTM C 618 regulations for a description of reinforcement grade fly ash). However, for producing asphalt, other grades may also be used as extenders.

Very fine dispersions of solids (smaller than −200 mesh) are created by circulating a coal slurry in an emulsifying grinder, resulting in a colloidal suspension. The emulsifying grinder may be placed upstream of the digestion reactor. The emulsifying grinder or other mechanical agitation device also creates heat from mechanical shear, thus helping to preheat and dewater the slurry.

After residing in the digestion reactor for a period of time, such as between 1 minute and 1 hour, the digestion reactor may dissolve or depolymerize soluble particles, although insoluble particles including mineral matter or fixed carbon may still remain. The very small particles result in a highly uniform viscous medium. These particles can be removed via filtration or centrifugation.

The solvents normally include a heavy oil such as decant oil or coal tar distillate, with a second solvent having additional hydrogen. The reason for adding additional hydrogen may be to enhance the dissolving power of the solvent blend, and to increase depolymerization while suppressing the tendency to re-polymerize. Tetralin, decalin, tetrahydrofuran, soybean oil, other vegetable oils, pine tar, pine oil, biogasification tars and other aromatic liquids may be used for this purpose. The oils may be optionally hydrogenated in order to add still more hydrogen.

Bio-oil is perceived to be beneficial from an environmental point of view, since it is a renewable fuel and may contribute less to global warming than fossil fuels.

The effect of bio-oil appears to be to chemically react with the larger polymerized coal molecules. The effect is to break apart or depolymerize the large coal molecules. The smaller coal fragments are stabilized by direct reaction with the small vegetable oil molecules. Since the reaction products are much smaller than the large polymerized coal molecules, the product is a liquid rather than a solid. Since these smaller molecules are stable there is little tendency for the coal molecules to repolymerize. Removal of ash also results in a reduced tendency for repolymerization, Hence the primary liquefaction pathway involves depolymerization and suppression of the tendency to repolymerize, rather than transfer of hydrogen from a solvent molecule to a coal molecule. This is in contrast to the mechanism of the Exxon Donor Solvent process, which is dependent upon transfer of hydrogen atoms from solvent molecules to coal molecules in order to render the coal molecules soluble. The important feature is that the coal is liquefied without hydrogen transfer. It is suspected that the reaction is initiated by the thermal depolymerization of the coal molecules and is terminated by reaction of the depolymerized coal molecules with the vegetable oil molecules. The depolymerization process may not be purely thermal but may be facilitated by reaction with the hydrogenated vegetable oil.

Though liquids with low ash content are generally more valuable than products such as asphalt, the production of at least one high-ash medium is almost unavoidable if coal is used as a feedstock. Asphalt is a value-added product, and as described above, synthetic asphalt may have important advantages from an environmental standpoint, and may be preferred over conventional asphalt produced as a petroleum refinery co-product.

Therefore, a need exists for producing asphalt as a co-product of coal liquefaction.

### SUMMARY

In an aspect, a method of producing asphalt pitch from liquefied coal includes liquefying coal via depolymerization and digestion of coal in a high temperature depolymerizing medium consisting of a blend of heavy aromatic hydrocarbon oils, mixed with coal, heating to a temperature between 350° C. and 450° C. to create digested coal, and concentrating solid mineral matter and insoluble carbon via centrifugation, to obtain a synthetic asphalt pitch incorporating dispersed mineral matter and insoluble carbon. The depolymerizing medium may be at least 15% by mass aromatic hydrocarbons. The depolymerizing medium is composed of two or more oils, in which the first oil is selected from a group of hydrocarbon liquids including: decant oil, coal tar distillate, anthracene oil, molten asphalt, recovered coal solvent or a blend of such liquids, such that the first depolymerizing oil boils at a temperature of 200 Celsius or higher at atmospheric pressure. A second depolymerizing oil is blended with said first oil, with said second oil being selected from a group of hydrocarbon liquids including: tetralin, decalin, naphthalene, soybean oil, vegetable oil, peanut oil, other agricultural oils, pine tar, gasification tar, lignin, and other oils, such that the average H/C mass ratio of the blended solvent is higher than 0.0675 and the total solvent to coal ratio is lower than 3:1.

The method may further include blending the synthetic asphalt pitch with an extender selected from the group consisting of crushed coal, crushed charcoal, crushed coke, low carbon pozzolanic fly ash, high carbon fly ash, talc, gypsum, crushed ceramic, crushed cement paste, crushed limestone, silica fume, coconut husks (or other fibrous, sorbent material), and soot and other crushed or pulverized inorganic material having a melting point above 1400° C., to produce a synthetic asphalt concrete. The method may further include removing low temperature boiling point hydrocarbons from the synthetic asphalt pitch thus resulting in a heavier molecular weight material, and reducing the ability of hydrocarbons to diffuse; e.g., intermingling with groundwater or soil. The asphalt pitch may include less than 20% aromatic content. The coal may be selected from the group of low rank coals consisting of sub-bituminous coal and lignite coal, and wherein coal tar is omitted from the solvent blend, in order to create reduced aromatic content both in said coal and said depolymerizing medium. A petroleum derivative may be included in the depolymerizing medium, with aromatic content of at least 15% but not more than 25%, wherein said petroleum derivative comprises over 50% of the mass of said depolymerizing medium. The asphalt concrete may include over 50% extender by mass. The petroleum derivative may be a light intermediate resin of petroleum having a viscosity of not lower than 40 cSt at 100° C., and not higher than 75 cSt. The method may produce asphalt pitch with reduced transport of aromatic chemicals in rainwater or groundwater, with said coal being selected from the group of low rank coals including sub-bituminous coal and lignite coal, and with coal tar omitted from the solvent blend, in order to create reduced aromatic content both in said coal and said depolymerizing medium. The extender may include at least 5% by weight of a sorbant. The sorbant may be at least one of a clay or a reinforcing organic material. The reinforcing organic material may be a fibrous material. The fibrous material may be coconut husk.

The first depolymerizing oil may be created from the liquid products of the method, such that the ratio of hydrogen mass to carbon mass (H/C) is at least 0.675 or higher. The second depolymerizing oil may be at least three percent but not more than 28% of the depolymerizing medium. The second depolymerizing oil may be at least one of tetralin, decalin, naphthalene, soybean oil, vegetable oil, peanut oil, other agricultural oils, pine tar, gasification tar, and lignin. The average H/C mass ratio of the depolymerizing medium may be higher than 0.0675. The total solvent to coal ratio may be lower than 3:1. The liquid products may include at least one of pitch, oil, mineral matter, and derivative fractions. The derivative fractions may be obtained by distillation, thermocracking, catalytic cracking, hydrocracking or steam cracking or other petroleum refining process. The second depolymerizing oil may be obtained by distillation of the hydrocarbon products from the method, such that the H/C mass ratio of said depolymerizing medium is at least 0.75.

In an aspect, a method for coal depolymerization may include mixing ground coal with a solvent 102, slurrying the coal and heating the mixture to greater than 100° C. 104, heating the mixture to a liquefaction temperature in a sealed container 108, venting the container to maintain a pressure of about 400 psi 110, cooling the depolymerized coal to about 100° C. to 200° C. 112, and separating ash and other insoluble matter from the depolymerized coal to obtain a centrate 114. The solvent may be a mixture of coal tar distillate (CTD) and vegetable oil. The ratio of CTD to vegetable oil may be 70:30. The ratio of solvent to coal may be in the range between 2:1 to 2.5:1. The solvent is non-hydrogenated. The coal may have an H/C greater than 0.065, an overall slurry H/C greater than 0.068, and an ash content less than 10%. The liquefaction temperature may be 400° C. or greater. The ash may be sold as asphalt pitch or gasifier fuel. The centrate may be further processed in at least one of a wiped film evaporator, distillation column, or other petroleum-type refining processes. The insoluble matter may be blended with extenders 118, such as coconut husks and peat moss, to obtain a synthetic asphalt concrete.

In an aspect, a method of co-producing hydrocarbon products including liquids and a liquid solid suspension asphalt pitch from liquefied coal may include mixing coal with a high temperature depolymerizing medium consisting of a blend of heavy aromatic hydrocarbon oils to form a coal mixture, heating the coal mixture to a temperature between 350° C. and 450° C. to create a depolymerized liquid phase coal, concentrating solid mineral matter and insoluble carbon via centrifugation to obtain a synthetic asphalt pitch incorporating dispersed mineral matter and insoluble carbon as an underflow or tails of centrifugation and a centrate, and optionally blending the synthetic asphalt pitch with additional extenders in addition to the mineral matter and insoluble coal, to produce a synthetic asphalt concrete. The extender may be selected from the group consisting of crushed coal, crushed charcoal, crushed coke, low carbon pozzolanic fly ash, high carbon fly ash, talc, gypsum, crushed ceramic, crushed cement paste, crushed limestone, silica fume, coconut husk, peat moss, clay, soot, and other crushed or pulverized inorganic material having a melting point above 1400° C. The depolymerizing medium may include two or more oils, wherein a first depolymerizing oil is selected from the group of consisting of decant oil, coal tar distillate, anthracene oil, molten asphalt, recovered coal solvent and a blend of the aforementioned liquids, wherein the first depolymerizing oil boils at a temperature of 200 Celsius or higher at atmospheric pressure. The second oil may be selected from the group consisting of tetralin, decalin, naphthalene, soybean oil, vegetable oil, peanut oil, other agricultural oils, pine tar, gasification tar, bitumen, oil sands extra heavy petroleum crude, petroleum residuum resulting from vacuum distillation processes, and lignin, and blended with the first depolymerizing oil in order to reduce the viscosity of the depolymerized liquid phase coal and to optionally enhance the solubility of coal in the first depolymerizing oil. The depolymerizing medium may be at least 15% by mass aromatic hydrocarbons. The method may further include removing low temperature boiling point hydrocarbons from the synthetic asphalt pitch thus resulting in a heavier molecular weight material, and reducing the ability of hydrocarbons to diffuse. The asphalt pitch may include less than 20% aromatic content. The average H/C mass ratio of the depolymerizing medium is higher than 0.0675 and the total depolymerizing medium to coal ratio is lower than 3:1. The depolymerizing medium may include a petroleum derivative with aromatic content of at least 15% but not more than 25%, wherein the petroleum derivative comprises over 50% of the mass of the depolymerizing medium. The asphalt concrete may include over 50% extender by mass. The petroleum derivative may be a light intermediate resin of petroleum having a viscosity of not lower than 40 cSt at 100° C., and not higher than 75 cSt. The coal may be selected from the group consisting of sub-bituminous coal and lignite coal. The extender may include at least 5% by weight of a sorbant. The sorbant may be at least one of a clay and a reinforcing organic material.

The method may further include before blending, heating the asphalt pitch to liberate a volatile matter and an entrained solvent. The first depolymerizing oil may be created from the liquid products of the method, wherein the ratio of hydrogen mass to carbon mass (H/C) is at least 0.675 or higher. The second oil may be at least three percent but not more than 28% of the depolymerizing medium. The second oil may be at least one of tetralin, decalin, naphthalene, soybean oil, vegetable oil, peanut oil, other agricultural oils, pine tar, gasification tar, and lignin. The liquid products may include at least one of pitch, oil, mineral matter, and derivative fractions. The derivative fractions may be obtained by at least one of distillation, thermocracking, catalytic cracking, hydrocracking or steam cracking and petroleum refining processes. The second oil may be obtained by distillation of the hydrocarbon products of the method, wherein the H/C mass ratio of the depolymerizing medium is at least 0.75.

In an aspect, a method for coal depolymerization may include mixing ground coal with a solvent, slurrying the coal and heating the mixture to greater than 100° C., heating the mixture to a liquefaction temperature in a sealed container, venting the container to maintain a pressure of about 400 psi, cooling the depolymerized coal to about 100° C. to 200° C., separating ash and insoluble matter from the depolymerized coal and obtaining a centrate, and blending the ash and insoluble matter with an extender. The extender may be selected from the group consisting of crushed coal, crushed charcoal, crushed coke, low carbon pozzolanic fly ash, high carbon fly ash, talc, gypsum, crushed ceramic, crushed cement paste, crushed limestone, silica fume, coconut husk, peat moss, clay, soot, and other crushed or pulverized inorganic material having a melting point above 1400° C. The solvent may be a mixture of coal tar distillate (CTD) and vegetable oil. The ratio of CTD to vegetable oil may be 70:30. The ratio of solvent to coal may be in the range between 2:1 to 2.5:1. The solvent may be non-hydrogenated. The coal may have an H/C greater than 0.065, an overall slurry H/C greater than 0.068, and an ash content less than 10%. The liquefaction temperature may be 400° C. or greater. The ash may be sold as asphalt pitch or gasifier fuel. The centrate may be further processed in at least one of a wiped film evaporator, distillation column, or other petroleum-type refining process.

These and other systems, methods, objects, features, and advantages of the present invention will be apparent to those skilled in the art from the following detailed description of the preferred embodiment and the drawings.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE FIGURES

The invention and the following detailed description of certain embodiments thereof may be understood by reference to the following figures:

FIG. 1 depicts a method for depolymerizing coal.

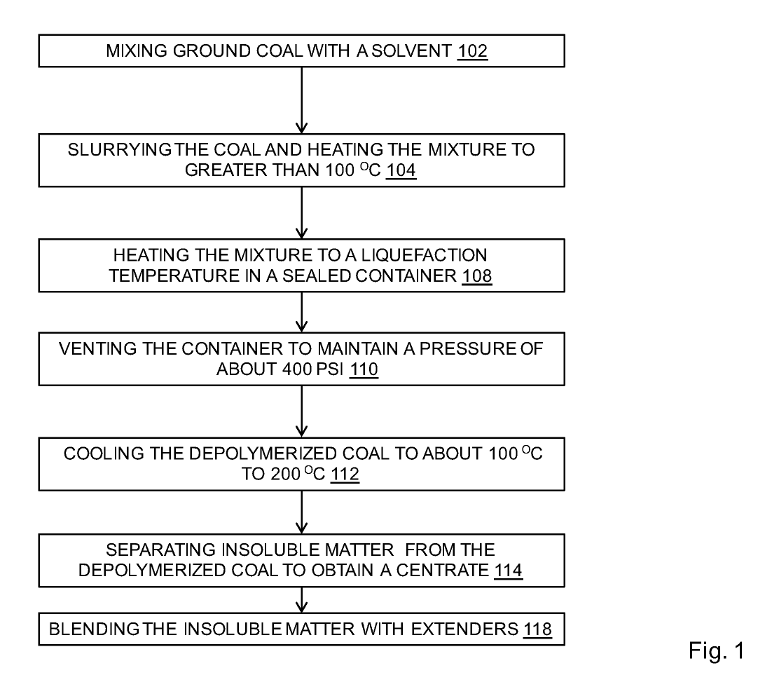

### DETAILED DESCRIPTION

Reference will now be made in detail to embodiments of the invention, examples of which are illustrated in the accompanying drawing. It is to be understood that other embodiments may be utilized and structural and functional changes may be made without departing from the respective scope of the invention.

Coal may be mixed with a solvent, such as hydrogenated vegetable oil or non-hydrogenated vegetable oil, in order to depolymerize or dissolve it to obtain coal liquids. One of the steps in obtaining a coal liquid is to remove any undissolved or un-depolymerized material, such as centrifuging the solids out of the coal liquid. These solids represent an opportunity for utilization in and use as asphalt pitch or asphalt concrete. However, to ensure that the resultant asphalt pitch or asphalt concrete is relatively environmentally friendly (by reducing or eliminating diffusion of aromatic molecules out of asphalt, where it might contact the environment including the ground, water or rainwater runoff), the aromatic content of the starting material could be reduced, both in the liquid starting material as well as by selecting low rank coal. In order to obtain asphalt pitch or asphalt concrete from centrifuge solids, additives could be included to polymerize and immobilize the asphalt, such as fly ash, rocks, concrete, coconut husk, peat moss, clay, or other fibrous material that is sorbant.

In one embodiment, the disclosure herein involves the creation of a supply of blended solvent, creating a mixture of solvent and crushed coal, liberating low boiling point liquids from said mixture, then heating the mixture to devolatilize the coal and solvent to create a hot liquid suitable for centrifugation; removing ash via centrifugation; distilling the ash-free hot liquid resulting in a liquid fraction as well as a pitch. The solvent is a hydrocarbon liquid with a ratio of moisture-free hydrogen-to-carbon content of at least 7.0 percent by mass, and aromaticity of at least 10%. One component of the blend may be a heavy aromatic oil derived from fossil fuel. One acceptable example is coal tar distillate obtained from a coke battery oven. Other examples of heavy aromatic oil include decant oil from petroleum refining, or other aromatic oils from petroleum refining having 7.0% hydrogen-to-carbon ratio and aromaticity of 10% or higher. Tars from pyrolysis of biomass, sewage, or other hydrocarbons may also contribute to such a blend. The components of the heavy oil could have a boiling temperature in the range of 200° C. to 450° C. and at least ten percent aromaticity (percentage of the solvent that consists of aromatic rings of carbon and hydrogen, with delocalized electrons). Lower boiling point liquids such as moisture (water) may be also present, but comprise less than 5.0% of the blended depolymerization medium. In one embodiment, low boiling point liquids may cause the system pressure to increase when they are heated to 400° C. in a digestion reactor.

Another desired component in the blended depolymerization medium is a bio-liquid with hydrogen content greater than about 7.0% by mass, and preferably greater than 10% by mass. One purpose of the bio-liquid may be to increase the fluidity of the depolymerization medium. A second function of the bio-liquid may be to increase the solubility of coal particles in the blended depolymerization medium. A third function of the bio-liquid may be to provide additional feedstock for conversion to fuels, pitches and other products. A fourth function of the bio-liquid may be to provide greater aliphaticity in the liquid product. Examples of the bio-liquid may be biodiesel, biogasoline, soybean oil, other non-hydrogenated vegetable oils, hydrogenated vegetable oils, algae derived bio-oil, alcohols, pyrolysis tars from biomass charring or from biomass coking, lignin or other biological source having high content of hydrocarbons and low concentration of ash producing material.

Optionally, coal may be dried by heating it to above 100° C. at ambient pressure. This is especially desirable for low rank coals having moisture content higher than 5.0 percent. This can be accomplished in a solvent bath. Further optional heating of the solvent may be done to less than about 240° C. at atmospheric pressure or lower, which can liberate lighter molecules including such as, for example, naphthalene. A cooled condenser is used to collect these lighter liquids.

Additional crushed or pulverized coal might be added to a synthetic asphalt pitch in order to raise its apparent softening temperature.

Other fillers such as crushed limestone, fly ash, coconut husks, or other fibrous and sorbent material may also be added as fillers to asphalt pitch.

Solvent is combined with coal and heated to between 385° C. and 430° C. for up to one hour in a tank reactor or flowing pipe reactor in order to depolymerize the coal, creating a liquid coal digest. As noted above, this temperature is sufficient to degrade or depolymerize other chemicals including naphthalene and for that reason a partial distillation may be desirable prior to the digestion process.

The coal can be bituminous coal, lignite coal or sub-bituminous coal, or a blend of those coals. Desirable attributes for the coal are: an ash level of 10% or below, dry basis volatile content of 30% or higher as measured by ASTM Standard D3172-13 or similar standard; hydrogen to carbon ratio could be at least 6.0%, as measured by ASTM Standard D3176. The coal is normally crushed to −25 mesh. By maintaining the combination of crushed coal and depolymerization medium together, a depolymerized coal digest is created without the apparent transfer of hydrogen from the solvent to the coal.

Centrifugation occurs after creating the liquid coal digest, and allowing the digest to cool to the rated temperature of said centrifuge. Removal of the ash also reduces the tendency of the coal to repolymerize. The centrifuge tails, consisting of ash and additional coal liquids entrained with the ash, represent a separate product stream. For example, the tails can be blended with asphalt or else used as a gasification fuel. Separation normally occurs at a temperature of about 100° C., or as hot as reasonably achievable in order to reduce the viscosity of the working fluid. The liquid fraction is referred to as a centrate.

The centrate is distilled into two or more fractions, to create at least a heavy hydrocarbon product as well as liberated volatiles with lower molecular weight. Depending on the temperature and pressure of the distillation step, ASTM Standard D 189, Conradson Carbon Yield, is often used to predict and characterize the yield of pitch. Binder Grade Pitch requires a softening temperature of about 110° C. as measured by ASTM D 450, and H/C ratio of about 4.6%. Optionally heating to 600° C. or higher temperatures can result in removal of virtually all volatiles, resulting in a coke and maximum liquid yield. Conversely, lower temperature distillation results in a lower softening temperature substance and lower yield of liquid.

The condensed liquid products contain many chemicals present in the digested coal, and for that reason these liquid products may be useful as a coal depolymerization medium. The phrase “depolymerization medium” refers to a liquid suitable for not only dissolving soluble molecular species, but which also breaks down large molecules. Distillate from approximately 250° C. to 400° C. atmospheric boiling point can be blended with other heavy oils to create additional depolymerization medium suitable for dissolving, depolymerizing, and/or digesting coal. Lighter liquids having H/C ratio higher than 6.8% are useful for increasing the yield of liquid products and decreasing the yield of pitch products. Alternatively distillate liquids may be part of a different product stream.

Another method for reducing the yield of pitch and increasing the yield of liquid products is to select coals with H/C mass ratio of 6.8% or higher, and ash below 6% by mass. Such coals are often associated with high volatile content and high fluidity.

In embodiments, an overall process for coal liquefaction or depolymerization may begin with mixing ground coal with a solvent, such as any of the solvents described herein, a mixture of coal tar distillate (CTD) and vegetable oil, CTD alone, vegetable oil alone, and the like. The ratio of CTD to vegetable oil may be 7:3, but any ratio of the two may work. In embodiments, the vegetable oil may be soybean oil, or any other suitable vegetable oil. The ratio of solvent to coal may be in the range between 2:1 to 2.5:1, however, other solvent:coal ratios may be possible. The liquefaction process may proceed in the absence of gaseous hydrogen or added hydrogen donor solvent. That is, solvents such as vegetable oil are not hydrogenated before use in coal liquefaction. Any coal may be used in the process, however certain coals may be more suitable, such as those coals with an H/C greater than 0.065, an overall slurry H/C greater than 0.068, and an ash content less than 10%.

The liquefaction process includes slurrying the coal in a loop and heating the mixture to greater than 100° C., or a temperature high enough, to boil off water. After water has evaporated (such as after a few cycles of evaporation or until a desired moisture level is achieved), the mixture is heated to a liquefaction temperature, such as 400° C., in a separate loop or container, for a period of time to achieve at least partial liquefaction, such as 10 minutes, 30 minutes, one hour or more. In embodiments, the container or loop may be sealed during this heating process. Excess pressure may be vented to maintain a pressure of about 400 psi.

The liquefied coal, now a coal extract, is cooled to about 100° C. to 200° C. and centrifuged, or otherwise subjected to a separation process, to remove ash and obtain a centrate. The high ash fraction may be sold as asphalt pitch or gasifier fuel.

The remaining liquid/centrate, which may have less than 1% ash level, may be further processed in a wiped film evaporator, distillation column, or other petroleum-type refining processes. Possible products from these further processing steps include heavy distillate, middle distillate, light distillate, fuels, pitch, binder grade pitch with a softening point 110° C., and the like. Further processing of these products may be possible, such as by coking to obtain a coke and other products, such as heavy crude oil.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

The use of the terms “a” and “an” and “the” and similar referents in the context of describing the disclosure (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above described embodiment, method, and examples, but by all embodiments and methods within the scope and spirit of the disclosure.

All documents referenced herein are hereby incorporated by reference.

What is claimed is:

1. A method of co-producing hydrocarbon products including liquids and a liquid solid suspension asphalt pitch from liquefied coal, comprising:
mixing coal with a high temperature depolymerizing medium consisting of a blend of heavy aromatic hydrocarbon oils to form a coal mixture;
heating the coal mixture to a temperature between 350° C. and 450° C. to create a depolymerized liquid phase coal;
concentrating solid mineral matter and insoluble carbon via centrifugation to obtain a synthetic asphalt pitch incorporating dispersed mineral matter and insoluble carbon as an underflow or tails of centrifugation and a centrate; and
blending the synthetic asphalt pitch with one or more additional extenders, in addition to the mineral matter and insoluble coal, to produce a synthetic asphalt concrete.

2. The method of claim 1, wherein the one or more additional extenders are selected from the group consisting of crushed coal, crushed charcoal, crushed coke, low carbon pozzolanic fly ash, high carbon fly ash, talc, gypsum, crushed ceramic, crushed cement paste, crushed limestone, silica fume, clay, soot, and other crushed or pulverized inorganic material having a melting point above 1400° C.

3. The method of claim 1, wherein the one or more additional extenders are selected from the group consisting of coconut husk and peat moss.

4. The method of claim 1, wherein the depolymerizing medium comprises two or more oils, wherein a first depolymerizing oil is selected from the group of consisting of decant oil, coal tar distillate, anthracene oil, molten asphalt, recovered coal solvent and a blend of the aforementioned liquids, wherein the first depolymerizing oil boils at a temperature of 200 Celsius or higher at atmospheric pressure.

5. The method of claim 4, wherein a second oil is selected from the group consisting of tetralin, decalin, naphthalene, soybean oil, vegetable oil, peanut oil, other agricultural oils, pine tar, gasification tar, bitumen, oil sands extra heavy petroleum crude, petroleum residuum resulting from vacuum distillation processes, and lignin, and blended with the first depolymerizing oil in order to reduce the viscosity of the depolymerized liquid phase coal and to optionally enhance the solubility of coal in the first depolymerizing oil.

6. The method of claim 1, wherein the depolymerizing medium is at least 15% by mass aromatic hydrocarbons.

7. The method of claim 1, wherein the asphalt pitch comprises less than 20% aromatic content.

8. The method of claim 1, wherein the average H/C mass ratio of the depolymerizing medium is higher than 0.0675 and the total depolymerizing medium to coal ratio is lower than 3:1.

9. The method of claim 1, wherein the depolymerizing medium comprises a petroleum derivative with aromatic content of at least 15% but not more than 25%, wherein the petroleum derivative comprises over 50% of the mass of the depolymerizing medium.

10. The method of claim 1, wherein the synthetic asphalt concrete comprises over 50% extender by mass.

11. The method of claim 1, wherein the one or more additional extenders include at least 5% by weight of a sorbant.

12. The method of claim 1, further comprising, before blending, heating the asphalt pitch to liberate a volatile matter and an entrained solvent.

13. A method for coal depolymerization, comprising:
mixing ground coal with a solvent;
slurrying the coal and heating the mixture to greater than 100° C.;
heating the mixture to a liquefaction temperature in a sealed container;
venting the container to maintain a pressure of about 400 psi;
cooling the depolymerized coal to about 100° C. to 200° C.;
separating ash and insoluble matter from the depolymerized coal and obtaining a centrate; and
blending the ash and insoluble matter with an extender.

14. The method of claim 13, wherein the extender is selected from the group consisting of coconut husk and peat moss.

15. The method of claim 13, wherein the solvent is a mixture of coal tar distillate (CTD) and vegetable oil.

16. The method of claim 15, wherein the ratio of CTD to vegetable oil is 70:30.

17. The method of claim 13, wherein the ratio of solvent to coal is in the range between 2:1 to 2.5:1.

18. The method of claim 13, wherein the solvent is non-hydrogenated.

19. The method of claim 13, wherein the coal has an H/C greater than 0.065, an overall slurry H/C greater than 0.068, and an ash content less than 10%.

20. The method of claim 13, wherein the liquefaction temperature is 400° C. or greater.

21. The method of claim 1, wherein the solvent is non-hydrogenated.

22. A method of co-producing hydrocarbon products including liquids and a liquid solid suspension asphalt pitch from liquefied coal, comprising:
mixing coal with a non-hydrogenated depolymerizing medium consisting of a blend of heavy aromatic, non-hydrogenated hydrocarbon oils to form a coal mixture;
heating the coal mixture to a temperature between 350° C. and 450° C. to create a depolymerized liquid phase coal; and
concentrating solid mineral matter and insoluble carbon via centrifugation to obtain a synthetic asphalt pitch incorporating dispersed mineral matter and insoluble carbon as an underflow or tails of centrifugation and a centrate.

23. The method of claim 22, further comprising, blending the synthetic asphalt pitch with additional extenders to produce a synthetic asphalt concrete.
